(19) United States
(12) Patent Application Publication
(10) Pub. No.: US 2026/0093634 A1
(43) Pub. Date: Apr. 2, 2026

(54) NON-ADJACENT CONNECTION OF HIGH-BANDWIDTH MEMORY CHIPLETS, I/O CHIPLETS, AND COMPUTE CHIPLETS THROUGH EMBEDDED LOGIC BRIDGES

(71) Applicant: OpenAI OpCo, LLC., San Francisco, CA (US)

(72) Inventors: Clive Chan, San Mateo, CA (US); Chian-min Richard Ho, Palo Alto, CA (US); Christopher Leary, Sunnyvale, CA (US); Ravi Narayanaswami, San Jose, CA (US); Devin Persaud, San Jose, CA (US); Kaushik Vaidyanathan, Santa Clara, CA (US)

(73) Assignee: OpenAI OpCo, LLC., San Francisco, CA (US)

(21) Appl. No.: 18/903,427

(22) Filed: Oct. 1, 2024

(51) Int. Cl. G06F 12/0893

(52) U.S. Cl. CPC G06F 12/0893; G06F 2212/305

(57) ABSTRACT

A system of high bandwidth memory (HBM) chiplets and compute chiplets includes embedded logic bridges that extend communication distances from the HBM chiplets to other chiplets beyond the ˜6 mm limit imposed by the JEDEC standard. The embedded logic bridges include high-speed (e.g., greater than 1 Gbps) communication circuits that drive communication signals longer distances without fading below the detection threshold of the receiver. The longer high-speed communication distances enable more HBM chiplets to connect to a compute chiplet (and other chiplets, such as I/O or other compute chiplets) to support computational workloads in high-performance computing and machine learning/artificial intelligence, which depend on access to large amounts of memory for efficient operations.

### BACKGROUND

Memory, particularly size, speed and configuration of, is a key aspect of fast efficient computing. For many computational tasks, computer chips can be more efficient when they have access to large amounts of dynamic random access memory (DRAM). In some processing, data stored in the DRAM of one chip is accessed by other chips in a computer system through network input/output (IO) traffic. Access to the data in DRAM can become a bottleneck for compute and communication workloads. To address such bottlenecks, high bandwidth DRAM, such as High Bandwidth Memory (HBM), was introduced and is used for high-performance computing (HPC) and machine learning (ML) or artificial intelligence (AI).

HBM can be placed together with compute and IO chiplets in a package. The HBM devices are connected to the other chiplets in a package through wires in an interposer, which also acts as a structural base for HBM stacks and other chiplets.

Data is communicated to and from the HBM to other chiplets through wires in the interposer, and these communications are driven by high-speed circuits in the chiplets. The high-speed circuits can be referred to as a “physical layer” or “PHY” for short. The PHYs drive electrical signals from chiplet to HBM and vice versa in accordance to a standard defined by the Joint Electron Device Engineering Council (JEDEC). To meet the per-pin speed targets, the JEDEC standard for HBM, HBM2, HBM2e, HBM3 and HBM3e, requires the stacked HBM device to be placed adjacent to the chiplet with which the stacked HBM device communicates. More particularly, the metal connections (e.g., wires) in the interposer are required to be less than about 6 mm. That is, the distance from the PHY bumps of the adjacent chiplet to the I/O signal bumps in the HBM device must be no more than about 6 mm. This specification for maximum communication distance from the HBM device ensures the integrity of the electrical signal so that reliable high-speed communication can occur between the HBM and the chiplet, thereby meeting JEDEC specified HBM speed targets.

This communication-distance limitation imposes a practical limit on the number of HBM devices that can support a given chiplet. Due to the limited on-chip real-estate that is proximate to a given chiplet (e.g., areas around the periphery of the chiplet that are within the 6 mm communication distance), the distance limitation imposed by the JEDEC standard for HBM also imposes a practical limit on the number of stacked HBM devices that can be used with and support the chiplet. Accordingly, improved technologies are desired that can allow greater communication distances among chiplets and HBM stacks/devices, without sacrificing the HBM speed targets.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1A illustrates an arrangement of memory stacks around a compute chiplet when the placement of memory stacks is limited due to a 6 mm maximum communication distance, in accordance with certain embodiments.

FIG. 1B illustrates an arrangement of memory stacks around a compute chiplet when the maximum communication distance is extended from 6 mm to 16 mm, in accordance with certain embodiments.

FIG. 2A illustrates a top-down view of a first example of a chiplet system using embedded logic bridges, in accordance with certain embodiments.

FIG. 2B illustrates a side cut-away view of the first example of a chiplet system using embedded logic bridges, in accordance with certain embodiments.

FIG. 3A illustrates a block diagram for an example transformer neural network architecture, in accordance with certain embodiments.

FIG. 3B illustrates a block diagram for an example encoder of the transformer neural network architecture, in accordance with certain embodiments.

FIG. 3C illustrates a block diagram for an example decoder of the transformer neural network architecture, in accordance with certain embodiments.

FIG. 4 illustrates a second example of a chiplet system using embedded logic bridges, in accordance with certain embodiments.

FIG. 5 illustrates a third example of a chiplet system using embedded logic bridges, in accordance with certain embodiments.

FIG. 6 illustrates a fourth example of a chiplet system using embedded logic bridges, in accordance with certain embodiments.

FIG. 7 illustrates a block diagram of an example controller and physical layer (PHY), in accordance with certain embodiments.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

In some aspects, the techniques described herein relate to a computing system including: a compute chiplet arranged on a substrate and including an integrated circuit configured to perform logic and or computations; peripheral chiplets arranged on the substrate in a neighborhood around the compute chiplet, the peripheral chiplets including a nearest-neighbor chiplet and a next-nearest-neighbor chiplet, the nearest-neighbor chiplet being adjacent to the compute chiplet without a chiplet therebetween, and the nearest-neighbor chiplet being between the next-nearest-neighbor chiplets and the compute chiplet; and one or more embedded logic bridges embedded in the substrate, including active circuitry providing communications between the compute chiplet and the next-nearest-neighbor chiplet.

In some aspects, the techniques described herein relate to a computing system, wherein the nearest-neighbor chiplet is in a first rank with respect to the compute chiplet and the next-nearest-neighbor chiplet is in a second rank with respect to the compute chiplet, and the second rank is farther from the compute chiplet than the first rank.

In some aspects, the techniques described herein relate to a computing system, wherein: the one or more embedded logic bridges include an on-chip network including metal oxide semiconductor field effect transistors.

In some aspects, the techniques described herein relate to a computing system, wherein: the one or more embedded logic bridges include physical-layer communication circuitry that drive signals from the next-nearest-neighbor chiplet to the compute chiplet.

In some aspects, the techniques described herein relate to a computing system, wherein: the one or more embedded logic bridges include other physical-layer communication circuitry that drive other signals from the compute chiplet to the next-nearest-neighbor chiplet.

In some aspects, the techniques described herein relate to a computing system, wherein: the one or more embedded logic bridges include a controller that processes data from the next-nearest-neighbor chiplet before the data is converted to the signals that are driven to the compute chiplet by the physical-layer communication circuitry, and the one or more embedded logic bridges include another controller that processes other data from the compute chiplet before the data is converted to the other signals that are driven to the next-nearest-neighbor chiplet by the other physical-layer communication circuitry.

In some aspects, the techniques described herein relate to a computing system, further including an interposer between the peripheral chiplets and the one or more embedded logic bridges, the interposer consisting of passive circuitry.

In some aspects, the techniques described herein relate to a computing system, wherein: the active circuitry includes high-speed communication circuitry providing communication speeds greater than or equal to 1 Gbps, and the high-speed communication circuitry is configured to drive signals from the compute chiplet at least 10 mm without an amplitude of the signals being attenuated below a predefined detection threshold.

In some aspects, the techniques described herein relate to a computing system, wherein the next-nearest-neighbor chiplet is a high bandwidth memory stack of dynamic random access memory.

In some aspects, the techniques described herein relate to a computing system, wherein: the nearest-neighbor chiplet is another high bandwidth memory stack of dynamic random access memory, the one or more embedded logic bridges include first physical-layer communication circuitry that drive signals from the next-nearest-neighbor chiplet to the compute chiplet, the one or more embedded logic bridges include second physical-layer communication circuitry that drive signals from the nearest-neighbor chiplet to the compute chiplet, and the one or more embedded logic bridges include third physical-layer communication circuitry that drive the signals from the compute chiplet to the next-nearest-neighbor chiplet and the nearest-neighbor chiplet.

In some aspects, the techniques described herein relate to a computing system, wherein the one or more embedded logic bridges includes a first controller and a first physical layer near the next-nearest-neighbor chiplet, the first physical layer driving signals from the high bandwidth memory stack to the compute chiplet, and the one or more embedded logic bridges includes a second controller and a second physical layer near the compute chiplet, the second physical layer driving the signals from the compute chiplet to the next-nearest-neighbor chiplet, the second controller and the second physical layer being a die-to-die controller and a die-to-die physical layer, respectively.

In some aspects, the techniques described herein relate to a computing system, wherein the next-nearest-neighbor chiplet is another compute chiplet or an I/O chiplet, and the I/O chiplet is configured to provide a serializer-deserializer based interface or double data rate based interface.

In some aspects, the techniques described herein relate to a computing system, wherein the one or more embedded logic bridges includes a first controller and a first physical layer near the next-nearest-neighbor chiplet, the first physical layer driving signals from the next-nearest-neighbor chiplet to the compute chiplet, the first controller and the first physical layer being a die-to-die controller and a die-to-die physical layer, respectively, and the one or more embedded logic bridges includes a second controller and a second physical layer near the compute chiplet, the second physical layer driving the signals from the compute chiplet to the next-nearest-neighbor chiplet, the second controller and the second physical layer being a die-to-die controller and a die-to-die physical layer, respectively.

In some aspects, the techniques described herein relate to a computing system, wherein the active circuitry includes components that extend a signal distance that communication signals can be sent between the compute chiplet and the next-nearest-neighbor chiplet.

In some aspects, the techniques described herein relate to a computing system, wherein: the next-nearest-neighbor chiplet is spaced from the compute chiplet by at least a characteristic length of the peripheral chiplets, and the active circuitry extends a range of communications between the compute chiplet and the peripheral chiplets to be at least twice the characteristic length, wherein the characteristic length of the peripheral chiplets is a width or a length of one of the peripheral chiplets or the characteristic length is 6 mm, 8 mm, or 10 mm.

In some aspects, the techniques described herein relate to a computing system, wherein the active circuitry includes an amplifier that is configured to increase an amplitude of communication signals to compensate for signal attenuation over a distance greater than 8 mm, 10 mm, 12 mm, or 15 mm.

In some aspects, the techniques described herein relate to a computing system, wherein the active circuitry includes a repeater that detects signals and then resends the signals.

In some aspects, the techniques described herein relate to a computing system, wherein: the peripheral chiplets includes an additional chiplet, the nearest-neighbor chiplet and the next-nearest-neighbor chiplet being arranged between the additional chiplet and the compute chiplet, and the nearest-neighbor chiplet is in a first rank with respect to the compute chiplet, the next-nearest-neighbor chiplet is in a second rank with respect to the compute chiplet, the additional chiplet is in a third rank with respect to the compute chiplet, and the third rank is farther from the compute chiplet than the second rank, and the second rank is farther from the compute chiplet than the first rank.

In some aspects, the techniques described herein relate to a computing system, wherein: the compute chiplet is configured to perform a memory intensive task, and the peripheral chiplets include more HBMs than can fit along a shoreline of the compute chiplet, and the memory intensive task is one or more of (i) a high-performance computing task; (ii) a graphics processing task; or (iii) a machine learning task.

In some aspects, the techniques described herein relate to a computing system, wherein the memory intensive task is the machine learning task and the machine learning task includes a calculation selected from the group consisting of a weighted sum calculation; rectified linear unit calculation, a matrix multiplication; an add and normalize calculation; and a multiheaded attention calculation.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art for longer communication distances between High Bandwidth Memory (HBM) chiplets and other chiplets in a system of chiplets. The 6 mm communication signal limit imposed by JEDEC HBM standards creates a shoreline problem in which the number of HBM chiplets supporting computations on a compute chiplet is limited by the size of the HBM chiplets (e.g., between 10 mm² and 50 mm²) and the length of the shoreline of the compute chiplet (e.g., between 30 mm and 40 mm). That is, previous high-speed communication limits imposed a practical limitation that HBM chiplets had to be nearest neighbors to (e.g., abutted with) the compute chiplet.

The systems disclosed herein use embedded logic bridges to enable longer distances for high-speed communications, creating a new possibility that HBM chiplets can be arranged in a second rank around a compute chiplet (e.g., a next-nearest neighbor to the compute chiplet) or even in a third rank around a compute chiplet (e.g., a next-next-nearest neighbor to the compute chiplet), significantly increasing the amount of dynamic random access memory (DRAM) that is accessible to a compute chiplet for memory intensive computations, such as encountered in machine learning (ML) using large ML models with many nodes. For example, embedded logic bridges can increase high-speed, die-to-die communications from ˜6 mm to ˜30 mm or more).

According to certain non-limiting examples, integrated circuits (IC) in the embedded logic bridges can function as die-to-die controllers and physical layers (PHY) for the respective chiplets to drive the communication signals longer distances. Additionally or alternatively, on-chip networks on the embedded logic bridges can provide buffer circuits, amplifiers, and/or repeaters that enable longer communications between chiplets.

The longer communication distances between chiplets can also enable larger systems of chiplets with chiplets that are four or five characteristic lengths (e.g., having space for three or four other chiplets between them) apart being able to communicate. A characteristic length can be a typical width of the chiplets (e.g., the characteristic length can be in the range 4 mm to 10 mm, depending on the size of chiplets used for a given application). The systems of chiplets can include, e.g., HBM stacks, input/output (I/O) chiplets, and compute chiplets arranged in various configurations.

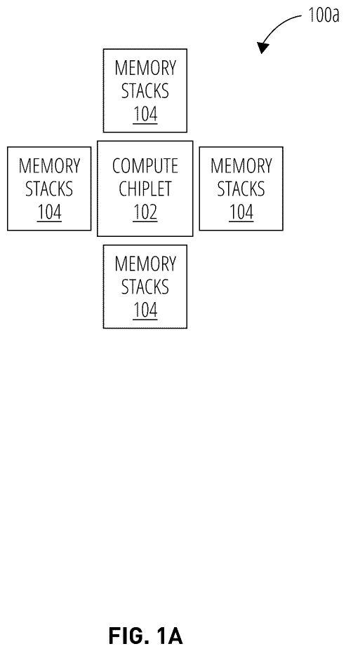

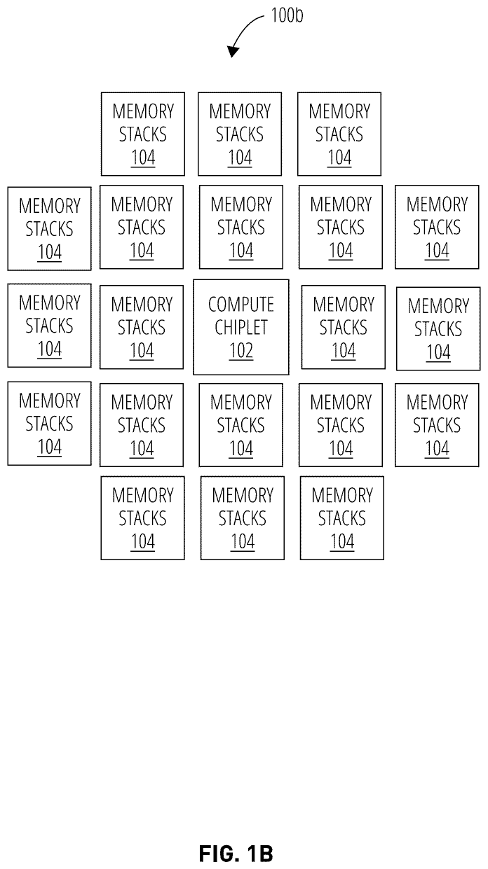

FIG. 1A illustrates an example of a system 100a that includes compute chiplet 102 surrounded by memory stacks 104. In this case, there are four memory stacks.

Compute chiplet 102 can be an integrated circuit (IC) on a small silicon die that contains a specific function and is designed to be combined with other chiplets to create a larger system. The chiplets can then be packaged together and sold as a single component.

According to certain non-limiting examples, compute chiplet 102 can be used for high-performance systems where custom silicon would be beneficial, such as in datacenters, the cloud, generative artificial intelligence (AI), and machine learning (ML). For example, a system including a compute chiplet (e.g., compute chiplet 102) can be used to implement functions like central processing units (CPUs), input/output (I/O) units, and accelerators. In a system of chiplets (e.g., compute chiplet 102) a processing unit, AI accelerator, and memory stacks can communicate and share data as if they were all on the same chip. Different types of chiplets can be combined to form a particular system for specified computation tasks.

Chiplets offer several advantages over other systems on chip (SoC), which are monolithic being fabricated on a single silicon die. In chiplet-based architectures, different functional components are integrated into separate dies or chiplets within a single package. For example, chiplets are smaller, functional units that can be combined to form a larger, more complex system-on-chip (SoC). Each chiplet might handle different functions, such as processing, memory, or I/O, thereby enabling modular design, flexibility, scalability, and cost-efficiency.

Memory stacks 104 can be high bandwidth memory (HBM). HBM can use a stacked configuration that is implemented using a 3D-stacked design in which multiple layers of dynamic random access memory (DRAM) chips are stacked vertically, connected through through-silicon vias (TSVs), which allow for high-speed data transfer between the layers and the logic chiplet.

Communication between the dies on a chiplet system can be performed, e.g., in accordance with a standard set out by the Joint Electron Device Engineering Council (JEDEC). Communication channels transfer data between different chiplets or dies. For optimal performance, the communication channels will handle high bandwidth and low latency.

As discussed above, some computational tasks for compute chiplet 102 can benefit from a large amount of dynamic random access memory (DRAM) being accessible to perform arithmetic and logic operations on compute chiplet 102. Access to the data in DRAM can become a bottleneck for compute and communication workloads, hence high bandwidth DRAM, such as High Bandwidth Memory (HBM), can be used in computer chips for high-performance computing (HPC) and machine learning (ML).

In FIG. 1A HBM stacks (e.g., memory stacks 104) can be placed together with compute chiplet 102 (and possibly IO chiplets) in a package. Memory stacks 104 can be connected to compute chiplet 102 through wires in an interposer. Alternatively, memory stacks 104 can be connected to compute chiplet 102 through wires in embedded passive bridge dies, wherein the bridge dies are embedded in the package.

As discussed above, the JEDEC standard for HBM (e.g., standards HBM, HBM2, HBM2e, HBM3 and HBM3) impose a distance limitation of a 6 mm for the wires extending from the PHY bumps of compute chiplet 102 to I/O signal bumps of memory stacks 104. This requirement limits the number of memory stacks 104 that can support compute chiplet 102 due to limited number of memory stacks 104 that can be placed adjacent to compute chiplet 102. This is called the shoreline limitation. In FIG. 1A the number of memory stacks 104 satisfying within the 6 mm communication distance is limited to four HBM stacks. For example, the width of an HBM stack can be greater than 5 mm, and the length of the HBM can be greater than or equal to 10 mm. Furthermore, for CMOS nodes, the peripheral length of a compute chiplet (also referred to as the chiplet shoreline) can be up to ˜32 mm. Consequently, when using JEDEC standard communication and using PHYs on the compute chiplet and on the HBM stacks, the number of HBM stacks that can be connected to a compute chiplet can have an upper bound of about four HBM stacks supporting the compute chiplet. The systems disclosed herein enable longer communication distances, thereby increasing the number of HBM stacks that can be connected to and support a compute chiplet.

FIG. 1B illustrates that, in system 100b, the number of memory stacks 104 that can connect to and support a compute chiplet can increase from four in system 100a to 20 in system 100b (i.e., a 5-fold increase) by increasing the communication distance from ˜6 mm to ˜16 mm. By increasing the amount of DRAM memory available to compute chiplet 102 more memory-intensive computation can be efficiently performed.

Examples of computations that can benefit from more DRAM memory can include, e.g., (1) computing large models; (2) computing with large datasets; (3) complex computations; (4) graph data computations; (5) graphics processing; and (6) generative and reinforcement learning. Large models include deep learning models with many parameters and layers. Computations using large datasets use large amounts of DRAM for methods that process or augment large volumes of data. Complex computations can use large amounts of DRAM for high-performance computing and intensive matrix operations. Graph-based models can use large amounts of DRAM for computations requiring large adjacency matrices. Generative and reinforcement learning use large amounts of DRAM to hold many values that are output from one layer and input to the next layer of a large neural network. These models can involve large networks and extensive data handling.

Further, HBM chiplets can be used in graphics processing units (GPUs s) that are used for gaming, professional graphics, and rendering applications, where high memory bandwidth can be used for handling complex graphics workloads. In high-performance computing (HPC) systems, HBM chiplets can be used to support intensive computational tasks that require large amounts of data. In AI and ML, workloads often involve processing large datasets and complex models, making the high bandwidth of HBM chiplets advantageous for accelerating these tasks.

Greater communication distances are realized using active circuitry in embedded logic bridges. For example, advanced packaging technology can be used to integrate chiplets using an embedded bridge. An embedded bridge is a piece of silicon that is placed into a cavity in a substrate (e.g., an organic substrate) to connect two or more chiplets. The embedded bridge can include metal layers that are used to provide electrical connectivity between the chiplets. For example, the embedded bridges can be used to replace a silicon interposer to overcome limitations due to reticle size limits of silicon manufacturing and to provide equivalent or similar functionality at lower cost.

Further, the embedded bridges can include logic (e.g., active circuits) that enable longer communication distances. For example, the embedded logic bridge can provide the functionality of a controller for HBM stacks. Additionally or alternatively, the embedded logic bridge can provide the functionality of high-speed PHY circuits for communicating between the chiplets in a package (e.g., die-to-die (D2D) interface, such as Universal Chiplet Interconnect Express (UCIe)).

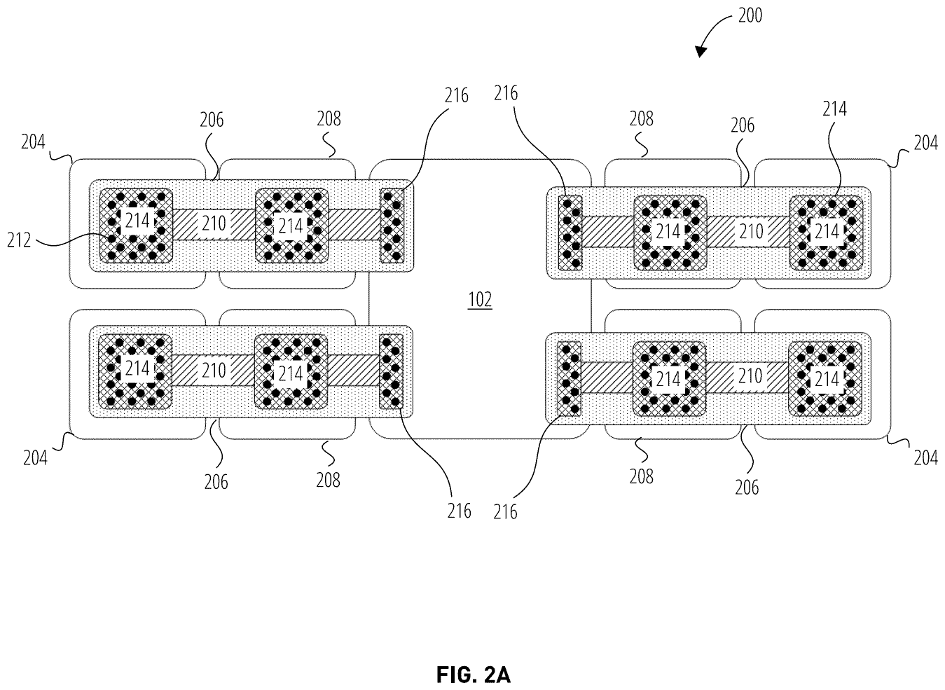

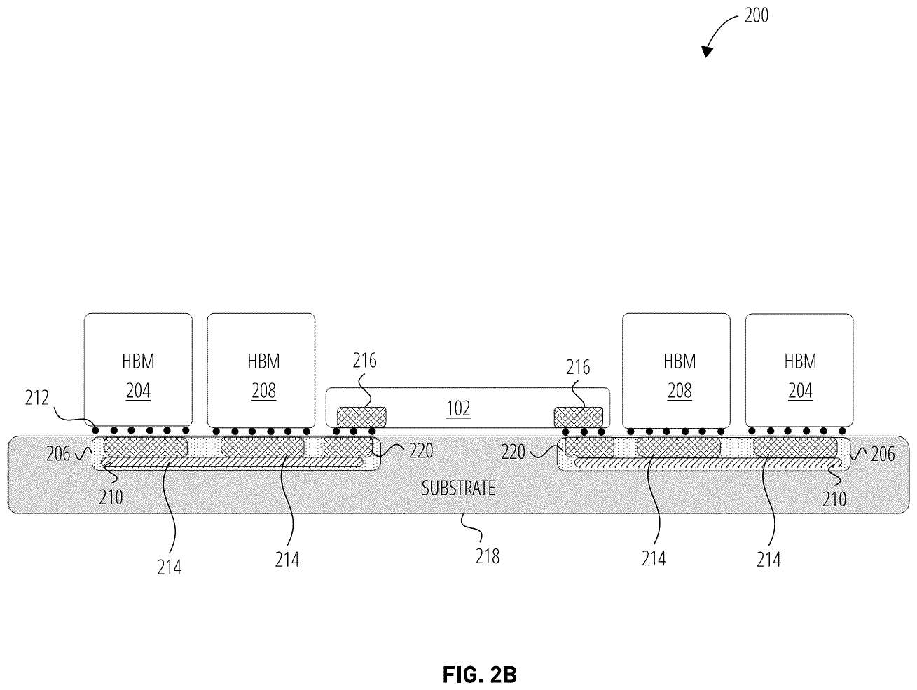

FIG. 2A and FIG. 2B show an example of using embedded logic bridges (e.g., embedded logic bridge 206) to extend communication distances between chiplets. FIG. 2A shows a top view of system 200, and FIG. 2A shows a side, cutaway view of system 200. Near HBM stacks 208 is a nearest-neighbor chiplet, and far HBM stacks 204 is a next-nearest-neighbor chiplet.

System 200 includes far HBM stacks 204 and near HBM stacks 208 that are connected to compute chiplet 102 through embedded logic bridges 206. Compute chiplet 102 includes D2D PHY and controller 216, which is connected through connection bumps 212 to embedded logic bridge 206. Embedded logic bridge 206 includes D2D PHY and controller 220. The functionality of the die-to-die interface from compute chiplet 102 can be split between D2D PHY and controller 216 and D2D PHY and controller 220 (as shown in FIG. 2B). By offloading some or all of the D2D interface functionality to embedded logic bridge 206, the logic on compute chiplet 102 is freed to perform other logic/computations. D2D PHY and controller 220 and 214 can include physical-layer communication circuitry that drives signals from the extended distance between the next-nearest-neighbor chiplet (e.g., far HBM stacks 204) and compute chiplet 102.

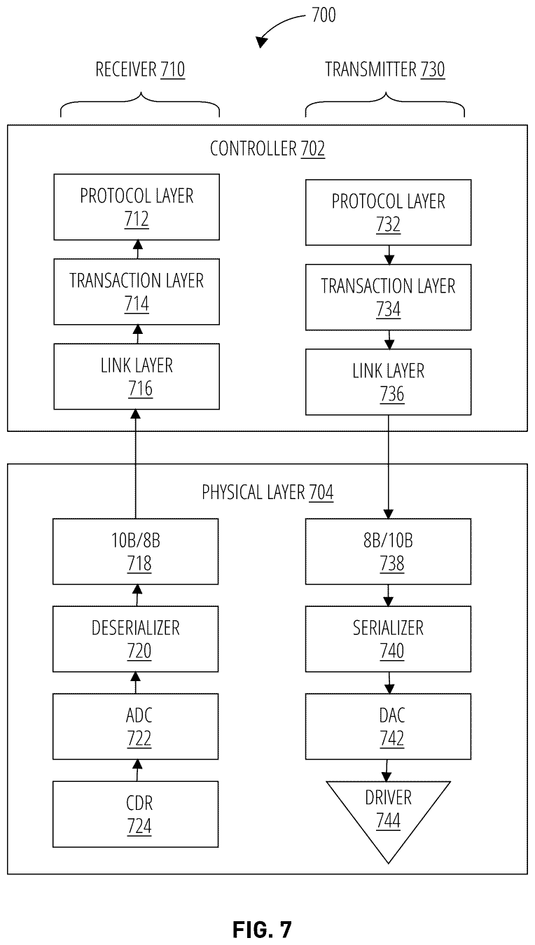

In addition to the logic of D2D PHY and controller 220, embedded logic bridge 206 includes on-chip network 210 and HBM PHY and controller 214. HBM PHY and controllers 214 can provide signals to the HBM stacks (e.g., far HBM stacks 204 and near HBM stacks 208) that conform to the JEDEC standard. An example of a PHY and controller is illustrated in FIG. 7. On-chip network 210 can include active circuits to drive the signal extended distance. For example, on-chip network 210 can include repeater circuits, amplifier circuits, buffer circuits, or other high-speed communication circuits to enable high-speed communications over extended distances (e.g., 20 mm, 30 mm or farther). On-chip network 210 can mitigate attenuation of communication signals as they are transmitted between compute chiplet 102 and far HBM stacks 204 or near HBM stacks 208, for example. Thus, embedded logic bridge 206 can overcome the shoreline limitation by providing chiplet-to-chiplet high-speed serial communication and then relaying the signals for more than one HBM stack within the embedded logic bridge.

The top-down view shown in FIG. 2A shows eight HBM stacks (e.g., four far HBM stacks 204 and four near HBM stacks 208). The eight HBM stacks are connected to compute chiplet 102 in two vertical ranks on each side of compute chiplet 102 using embedded logic bridges 206. In the absence of the D2D controllers and HBM controllers in embedded logic bridge 206, far HBM stacks 204 would be too far from compute chiplet 102 to allow high-speed communication.

FIG. 2B shows a side view of system 200. Embedded logic bridge 206 and the logic and analog circuits therein (e.g., on-chip network 210, HBM PHY and controller 214, and D2D PHY and controller 220) can be fabricated using Complementary Metal-Oxide-Semiconductor (CMOS) processes for manufacturing integrated circuits (ICs) using complementary pairs of p-type and n-type Metal-Oxide-Semiconductor Field-Effect Transistors (MOSFETs) on a semiconductor substrate. The fabrication process can include creating well regions, growing oxide layers, depositing and patterning polysilicon, implanting source and drain regions, and depositing and patterning metal layers for interconnects.

Photolithography can be used to pattern the respective layers into logic and analog circuits. In photolithography, a photoresist layer (negative or positive) on the semiconductor surface is exposed to light through openings in a mask to transfer the pattern of the photomask to the photoresist. The exposed areas undergo a chemical change, making them either soluble or insoluble in a developer solution. After development, the pattern is transferred onto the substrate through etching, chemical vapor deposition, or ion implantation processes.

Doping various regions with p-type or n-type dopants creates n-wells or p-wells and channel stop regions to form wells opposite to the substrate type to house the nMOS and pMOS transistors, with defined boundaries to prevent crosstalk. A thick oxide layer can be grown in the active regions, and a thin gate oxide layer is formed through thermal oxidation. Etching the polysilicon and SiO₂ layers according to the circuit pattern can prepare for the source and drain implants. Diffusion of dopants into the semiconductor can implant source, drain, and substrate contacts, thereby creating n+ or p+ regions in the wells for the source, drain, and substrate. Metallization layers can be patterned by creating contact windows and depositing and patterning the metal layers.

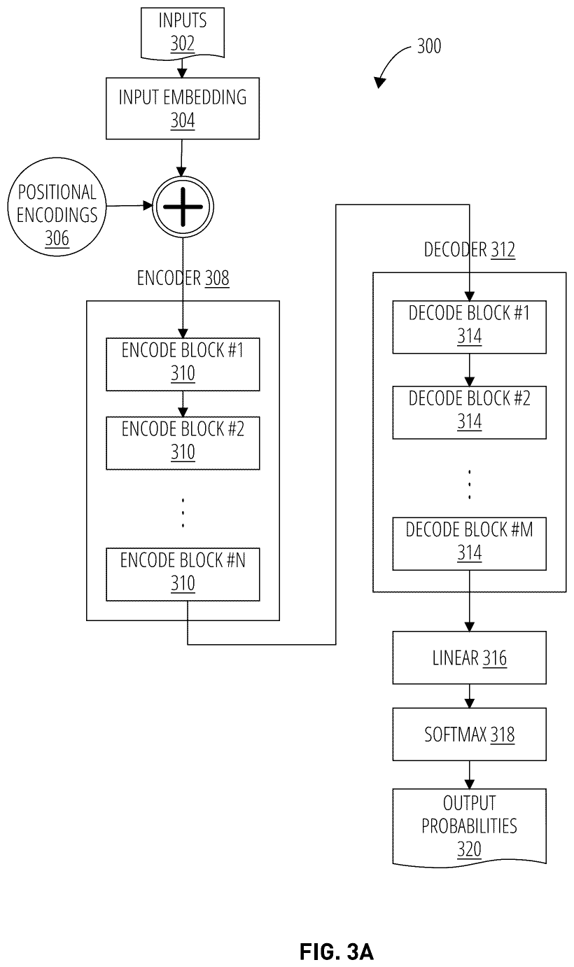

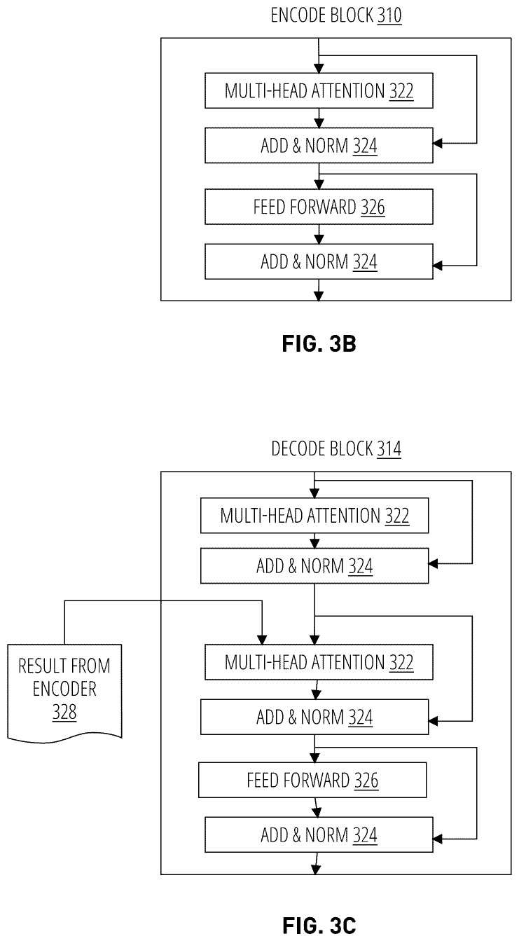

As discussed above, the embedded logic bridges increase the amount of DRAM accessible to compute chiplet 102 by increasing the number of HBM stacks that are in communication with compute chiplet 102. Increasing the compute's access to DRAM can improve performance for machine learning (ML) models such as multi-head attention computations (e.g., multi-head attention block 322 in FIG. 3B and FIG. 3C) in a transformer architecture, such as transformer architecture 300 in FIG. 3A. FIG. 3A, FIG. 3B, and FIG. 3C illustrate transformer architecture 300 that uses multi-head attention blocks 322. A multi-head attention block in a transformer is a layer that uses multiple attention heads to find similarities and correlations between input elements. Each head is a set of Query, Key, and Value vectors that can focus on different parts of the input, capturing different aspects of word relationships.

For example, when applying trained transformer architecture 300, the multi-head attention computations can include calculations of a scaled dot-product between vectors of query (Q), key (K), and value (V). The scaled dot-product can include matrix multiplication of Q and K, scaling the product, and a further matrix multiplication of the scaled product with V. For example, Q can be a vector of dimension “d,” whereas K and V can each be 100,000 vectors of dimension d. Thus, when system 200 is used in an accelerator for multi-head attention block 322 and compute chiplet 102 performs the above-noted steps, a large amount of DRAM provided by far HBM stacks 204 and near HBM stacks 208 can be used to store the product of the matrix multiplication of Q and K, the scaled product, and the product of the matrix multiplication of the scaled product with V.

Examples of ML models that use a transformer neural network (e.g., transformer architecture 300) can include, e.g., generative pretrained transformer (GPT) models and Bidirectional Encoder Representations from Transformer (BERT) models. The transformer architecture 300, which is illustrated in FIG. 3A, FIG. 3B, and FIG. 3C, includes inputs 302, input embedding block 304, positional encodings 306, encoder 308 including encode blocks 310, decoder 312 including decode blocks 314, linear block 316, softmax block 318, and output probabilities 320.

Input embedding block 304 is used to provide representations for words. For example, embedding can be used in text analysis. According to certain non-limiting examples, the representation is a real-valued vector that encodes the meaning of the word in such a way that words that are closer in the vector space are expected to be similar in meaning. Word embeddings can be obtained using language modeling and feature learning techniques, where words or phrases from the vocabulary are mapped to vectors of real numbers. According to certain non-limiting examples, the input embedding block 304 can be learned embeddings to convert the input tokens and output tokens to vectors of dimension have the same dimension as the positional encodings, for example.

Positional encodings 306 provide information about the relative or absolute position of the tokens in the sequence. According to certain non-limiting examples, positional encodings 306 can be provided by adding positional encodings to the input embeddings at the inputs to the encoder 308 and decoder 312. The positional encodings have the same dimension as the embeddings, thereby enabling a summing of the embeddings with the positional encodings. There are several ways to realize the positional encodings, including learned and fixed. For example, sine and cosine functions having different frequencies can be used. That is, each dimension of the positional encoding corresponds to a sinusoid. Other techniques of conveying positional information can also be used, as would be understood by a person of ordinary skill in the art. For example, learned positional embeddings can instead be used to obtain similar results. An advantage of using sinusoidal positional encodings rather than learned positional encodings is that doing so allows the model to extrapolate to sequence lengths longer than the ones encountered during training.

Encoder 308 uses stacked self-attention and point-wise, fully connected layers. Encoder 308 can be a stack of N identical layers (e.g., N=6), and each layer can be an encode block, as illustrated by encode block 310 shown in FIG. 3B. Each encode block 310 has two sub-layers: (i) a first sub-layer has a multi-head attention block 322 and (ii) a second sub-layer has a feed forward block 326, which can be a position-wise fully connected feed-forward network. The feed forward block 326 can use a rectified linear unit (ReLU).

Encoder 308 uses a residual connection around each of the two sub-layers, followed by an add & norm block 324, which performs normalization (e.g., the output of each sub-layer is LayerNorm(x+Sublayer(x)), i.e., the product of a layer normalization “LayerNorm” times the sum of the input “x” and output “Sublayer(x)” pf the sublayer LayerNorm(x+Sublayer(x)), where Sublayer(x) is the function implemented by the sub-layer). To facilitate these residual connections, all sub-layers in the model, as well as the embedding layers, produce output data having a same dimension.

Similar to encoder 308, decoder 312 uses stacked self-attention and point-wise, fully connected layers. Decoder 312 can also be a stack of M identical layers (e.g., M=6), and each layer can be a decode block, as illustrated by decode block 312 shown in FIG. 3B. In addition to the two sub-layers (i.e., the sublayer with multi-head attention block 322 and the sub-layer with feed forward block 326) found in encode block 310, decode block 314 can include a third sub-layer, which performs multi-head attention over the output of the encoder stack. Similar to encoder 308, decoder 312 uses residual connections around each of the sub-layers, followed by layer normalization. Additionally, the sub-layer with multi-head attention block 322 can be modified in the decoder stack to prevent positions from attending to subsequent positions. This masking, combined with the fact that the output embeddings are offset by one position, can ensure that the predictions for position i can depend only on the known output data at positions less than i.

Linear block 316 can be a learned linear transformation. For example, when transformer architecture 300 is being used to translate from a first language into a second language, linear block 316 can project the output from the last decode softmax block 318 into word scores for the second language (e.g., a score value for each unique word in the target vocabulary) at each position in the sentence. For instance, if the output sentence has seven words and the provided vocabulary for the second language has 10,000 unique words, then 10,000 score values are generated for each of those seven words. The score values indicate the likelihood of occurrence for each word in the vocabulary in that position of the sentence.

Softmax block 318 then turns the scores from linear block 316 into output probabilities 320 (which add up to 1.0). In each position, the index provides for the word with the highest probability, and then maps that index to the corresponding word in the vocabulary. Those words then form the output sequence of transformer architecture 300. The softmax operation is applied to the output from linear block 316 to convert the raw numbers into output probabilities 320 (e.g., token probabilities).

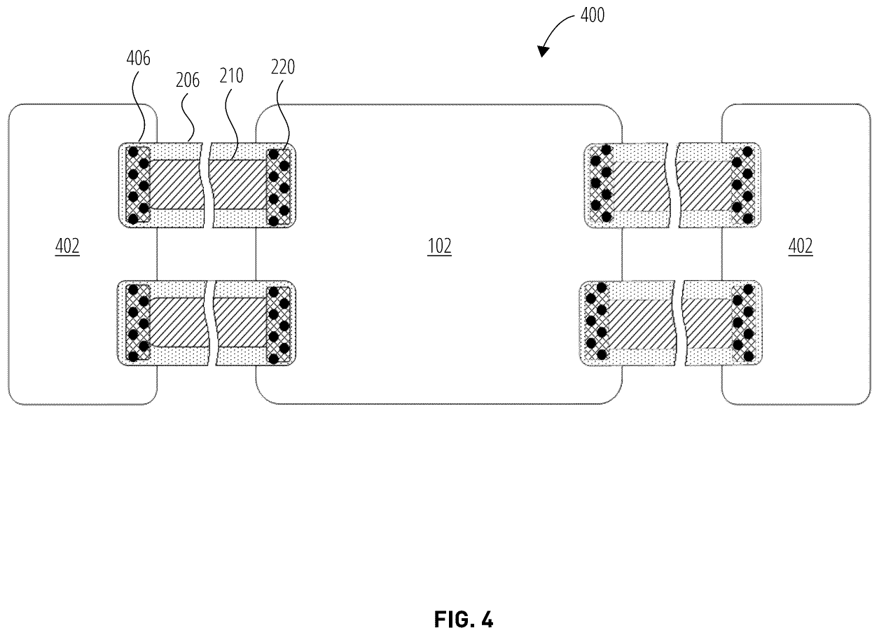

The advantages of the extended range for high-speed communications provided by embedded logic bridges 206 can apply to other chiplet systems. For example, FIG. 4 shows an example of chiplet system 400 that includes compute chiplet 102 connected to I/O chiplets 402 using embedded logic bridge 206. Embedded logic bridges 206 allow I/O chiplets 402 to be arranged at a distance of ˜10 mm or greater from compute chiplet 102. According to certain non-limiting examples, I/O chiplets 402 can use either serializer-deserializer based (SerDes-based) interfaces or double data rate based (DDR-based) interfaces.

According to certain non-limiting examples, the embedded logic bridge can be extended beyond the edge of the furthest HBM stack, allowing for IO controller logic and PHYs to be placed beyond the edge of the furthest HBM stack to provide communication channels from the compute chiplet to other chiplets or to off-chip interfaces. Compute chiplet 102 can communicate with the controllers on embedded logic bridge 206 through one or more die-to-die communication channels so that the amount of bandwidth is scalable. For example, similar to FIG. 2A and FIG. 2B, embedded logic bridge 206 can include D2D PHY and controller 406 and D2D PHY and controller 220 that provide tone or more die-to-die communication channels. In FIG. 4, the break lines in embedded logic bridge 206 indicate that the distance between I/O chiplets 402 and compute chiplet 102 can be large (e.g., 20 mm to 30 mm). Additionally or alternatively, embedded logic bridges 206 can be used to connect 102 to an abutted I/O chiplet as well as to a non-abutted I/O chiplet.

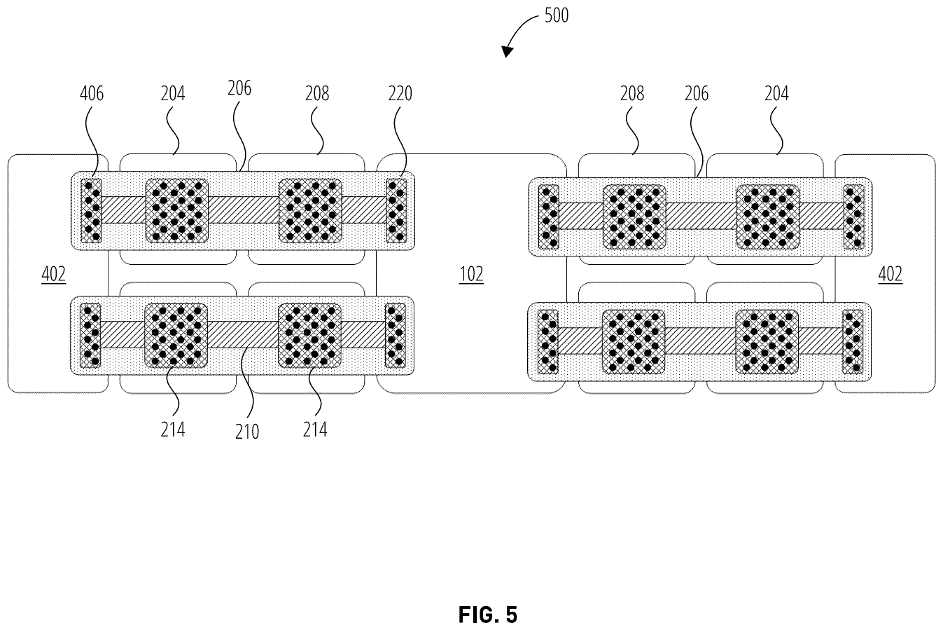

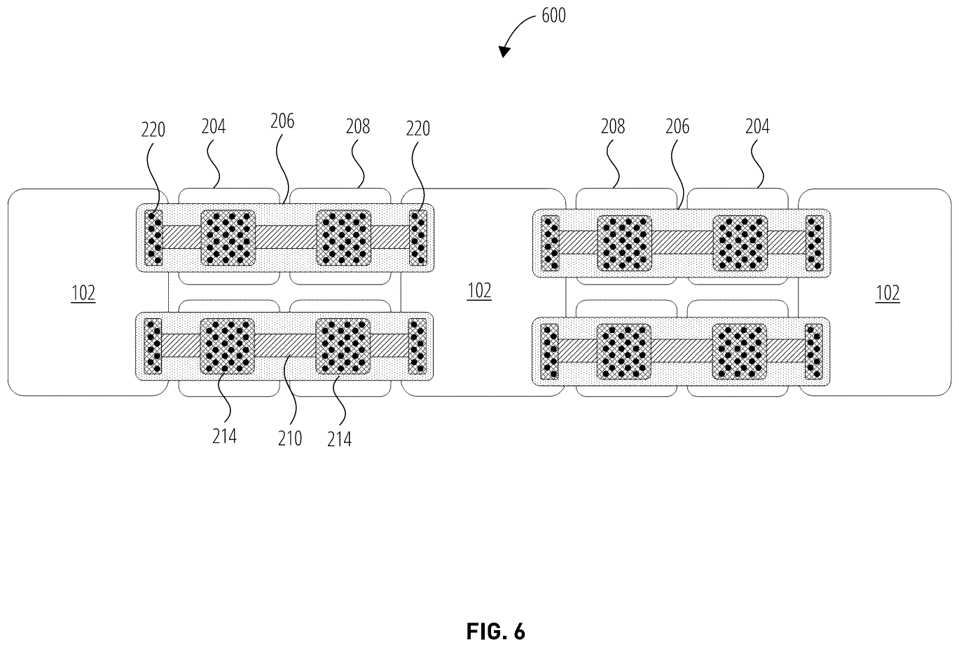

The advantages of the extended range for high-speed communications provided by embedded logic bridges 206 can apply to other chiplet systems that include HBM stacks, I/O chiplets, and a compute chiplet. FIG. 5 and FIG. 6 illustrate examples of such chiplet systems.

For example, FIG. 5 shows a chiplet system 500 that includes (from the middle to the edges) compute chiplet 102, near HBM stacks 208, far HBM stacks 204, and I/O chiplets 402. High-speed communications among the chiplets in chiplet system 500 is enabled by the active circuits in embedded logic bridges 206, including on-chip network 210, D2D PHY and controller 220, HBM PHY and controllers 214, and D2D PHY and controller 406. Near HBM stacks 208 is a nearest-neighbor chiplet, and far HBM stacks 204 is a next-nearest-neighbor chiplet.

The advantages of the extended range for high-speed communications provided by embedded logic bridges 206 can apply to other chiplet systems that include HBM stacks and multiple compute chiplets. FIG. 6 illustrate an example of such a chiplet system.

For example, FIG. 6 shows a chiplet system 600 that includes (from the middle to the edges) compute chiplet 102, near HBM stacks 208, far HBM stacks 204, and compute chiplets 102. High-speed communications among the chiplets in chiplet system 600 are enabled by the active circuits in embedded logic bridges 206, including on-chip network 210, D2D PHY and controller 220, and HBM PHY and controllers 214.

The above examples are non-limiting, and embedded logic bridges can be used in other systems of chiplets. For example, embedded logic bridges can be used to reach additional ranks of memory chiplets or I/O chiplets. Additionally or alternatively, embedded logic bridges can be used for tunnel die-to-die interfaces under HBMs. The embedded logic bridges can provide the advantages of increased bandwidth and/or lower energy consumption. Near HBM stacks 208 is a nearest-neighbor chiplet, and far HBM stacks 204 is a next-nearest-neighbor chiplet.

FIG. 7 illustrates a non-limiting example of a PHY and controller (e.g., PHY and controller 700). PHY and controller 700 include a receiver (e.g., RX 710) and a transmitter (e.g., TX 730). PHY and controller 700 can be D2D PHY and controller 216, D2D PHY and controller 220, and/or HBM PHY and controller 214.

For RX 710, controller 702 includes protocol layer 712, transaction layer 714, and link layer 716. For example, in a die-to-die interface, protocol layer 712 can define how data is formatted and what protocols are used for specific application-level interactions. Transaction layer 714 can handle error correction, flow control, and data segmentation to provide reliable, error-free data transfer between chiplets by handling error correction, flow control, and data segmentation. For example, protocol layer 712 and transaction layer 714 can implement cyclic redundancy check (CRC), forward error correction (FEC), and data routing. Link layer 716 can manage the physical and logical aspects of data transmission, including framing, error checking, and link maintenance. For example, link layer 716 can perform frame alignment and encoding.

In PHY 704, RX 710 includes a 10-bit to 8-bit decoder (e.g., 10 B/8 B 718), a deserializer (e.g., deserializer 720), an analog to digital converter (e.g., ADC 722), and clock and data recovery (e.g., CDR 724). The 10-bit to 8-bit decoder decodes 10-bit symbols into 8-bit data to provide error detection and correction. A deserializer converts a parallel bit stream into a serial bit stream to compensate for limited input/output channels.

For TX 730, controller 702 includes protocol layer 732, transaction layer 734, and link layer 736. For example, in a die-to-die interface, protocol layer 732 can define how data is formatted and what protocols are used for specific application-level interactions. Transaction layer 734 can handle error correction, flow control, and data segmentation to provide reliable, error-free data transfer between chiplets by handling error correction, flow control, and data segmentation. For example, protocol layer 732 and transaction layer 734 can implement cyclic redundancy check (CRC), forward error correction (FEC), and data routing. Link layer 736 can manage the physical and logical aspects of data transmission, including framing, error checking, and link maintenance. For example, link layer 736 can perform frame alignment and encoding.

In PHY 704, TX 730 includes an 8-bit to 10-bit to encoder (e.g., 8 B/10 B 738), a serializer (e.g., deserializer 740), a digital to analog converter (e.g., DAC 742), and clock and data recovery (e.g., driver 744). 8 B/10 B 738 can encode 8-bit data into 10-bit symbols to provide error detection and correction. A serializer converts a serial bit stream into a parallel bit stream to compensate for limited input/output channels.

According to certain non-limiting examples, the physical layer architecture can be SerDes-based (as illustrated herein) or parallel-based. A SerDes-based architecture can, e.g., include parallel-to-serial (serial-to-parallel) data conversion, impedance matching circuitry, and clock data recovery or clock forwarding functionality, and said architecture can support non-return to zero (NRZ) signaling or PAM-4 signaling for higher bandwidth, up to 112 Gbps, as non-limiting examples.

According to certain non-limiting examples, the parallel based architecture for physical layer 704 can include, e.g., many low-speed, simple transceivers in parallel, each including a driver and a receiver with forwarding clock techniques to further simplify the architecture, and this architecture can support DDR-type signaling, as a non-limiting example.

According to certain non-limiting examples, transaction layer 734 can be implemented similarly to a transport layer in the open systems interconnection (OSI) model, and protocol layer 712 can be implemented similarly to an application layer in the OSI model

According to certain non-limiting examples, PHY and controller 700 can include a phase-locked loop (PLL) and other circuitry for clock and data recovery (CDR).

According to certain non-limiting examples, protocol layer 712 and protocol layer 732 define communications between system on a chip (SoC) IPs using industry-standard or proprietary protocols. The protocol layers can specify rules and formats defining how data is transmitted and received between different dies, including specifications for signaling, encoding, and protocol-specific handshakes. The protocol layers enable data sent from one die to be correctly interpreted by another die. For example, in a high-bandwidth memory (HBM) interface or in multi-chip modules (MCMs), the protocol layer can include details on how to handle data packets, error correction, and acknowledgment signals.

According to certain non-limiting examples, transaction layer 714 and transaction layer 734 translate between protocol transfers or protocol packets defined by a bus protocol and individual transaction streams, and the transaction layers manage the flow control of those individual streams. The transaction layers can be related to higher-level operations and data transactions that are performed across the die-to-die interface.

The transaction layers are concerned with the higher-level operations and data transactions that are performed across the die-to-die interface. The transaction layers can handle, e.g., data request and response sequences, flow control, and transaction management. Further, the transaction layers can manage the logical units of communication that are often higher-level operations such as memory reads/writes or command executions.

According to certain non-limiting examples, link layer 716 and link layer 736 convert between the individual transaction streams and a single bitstream transmitted between chiplets.

According to certain non-limiting examples, a die-to-die (D2D) PHY (Physical Layer) provides the physical interface or communication layer that enables connecting and transmitting signals between semiconductor dies in a multi-chiplet system. It encompasses the electrical and physical aspects of the interconnects between the dies. The PHY handles the signaling, voltage levels, timing, and synchronization between the dies to provide reliable and efficient data transfer between the dies. According to certain non-limiting examples, the PHY can use single-ended signaling, differential signaling (e.g., LVDS), or high-speed serial interfaces. Further, the PHY can determine the voltage levels and signaling schemes that transmit and receive signals between the dies to ensures compatibility and proper voltage translation between different functional units, such as memory dies, processor dies, or accelerators. The PHY can handle the timing and synchronization aspects of the interconnects to ensure data integrity and reliable communication, including, e.g., clock distribution mechanisms, clock recovery circuits, and techniques for managing skew and latency.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data that cause or otherwise configure a general-purpose computer, special-purpose computer, or special-purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples, include magnetic or optical disks, solid-state memory devices, flash memory, USB devices provided with non-volatile memory, networked storage devices, and so on.

Devices implementing methods according to these disclosures can comprise hardware, firmware, and/or software, and can take any of a variety of form factors. Typical examples of such form factors include servers, laptops, smartphones, small form factor personal computers, personal digital assistants, and so on. The functionality described herein can also be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples, include magnetic or optical disks, solid state memory devices, flash memory, USB devices provided with non-volatile memory, networked storage devices, and so on.

Devices implementing methods according to these disclosures can comprise hardware, firmware, and/or software, and can take any of a variety of form factors. Typical examples of such form factors include servers, laptops, smart phones, small form factor personal computers, personal digital assistants, and so on. Functionality described herein can also be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A computing system comprising:
a compute chiplet arranged on a substrate and comprising an integrated circuit configured to perform logic and or computations;
peripheral chiplets arranged on the substrate in a neighborhood around the compute chiplet, the peripheral chiplets including a nearest-neighbor chiplet and a next-nearest-neighbor chiplet, the nearest-neighbor chiplet being adjacent to the compute chiplet without a chiplet therebetween, and the nearest-neighbor chiplet being between the next-nearest-neighbor chiplets and the compute chiplet; and
one or more embedded logic bridges embedded in the substrate, comprising active circuitry providing communications between the compute chiplet and the next-nearest-neighbor chiplet.

2. The computing system of claim 1, wherein the nearest-neighbor chiplet is in a first rank with respect to the compute chiplet and the next-nearest-neighbor chiplet is in a second rank with respect to the compute chiplet, and the second rank is farther from the compute chiplet than the first rank.

3. The computing system of claim 1, wherein:
the one or more embedded logic bridges include an on-chip network comprising metal oxide semiconductor field effect transistors.

4. The computing system of claim 1, wherein:
the one or more embedded logic bridges include physical-layer communication circuitry that drive signals from the next-nearest-neighbor chiplet to the compute chiplet.

5. The computing system of claim 4, wherein:
the one or more embedded logic bridges include other physical-layer communication circuitry that drive other signals from the compute chiplet to the next-nearest-neighbor chiplet.

6. The computing system of claim 5, wherein:
the one or more embedded logic bridges include a controller that processes data from the next-nearest-neighbor chiplet before the data is converted to the signals that are driven to the compute chiplet by the physical-layer communication circuitry; and
the one or more embedded logic bridges include another controller that processes other data from the compute chiplet before the data is converted to the other signals that are driven to the next-nearest-neighbor chiplet by the other physical-layer communication circuitry.

7. The computing system of claim 1, further comprising an interposer between the peripheral chiplets and the one or more embedded logic bridges, the interposer consisting of passive circuitry.

8. The computing system of claim 1, wherein:
the active circuitry includes high-speed communication circuitry providing communication speeds greater than or equal to 1 Gbps, and
the high-speed communication circuitry is configured to drive signals from the compute chiplet at least 10 mm without an amplitude of the signals being attenuated below a predefined detection threshold.

9. The computing system of claim 1, wherein the next-nearest-neighbor chiplet is a high bandwidth memory stack of dynamic random access memory.

10. The computing system of claim 9, wherein:
the nearest-neighbor chiplet is another high bandwidth memory stack of dynamic random access memory;
the one or more embedded logic bridges include first physical-layer communication circuitry that drive signals from the next-nearest-neighbor chiplet to the compute chiplet;
the one or more embedded logic bridges include second physical-layer communication circuitry that drive signals from the nearest-neighbor chiplet to the compute chiplet; and
the one or more embedded logic bridges include third physical-layer communication circuitry that drive the signals from the compute chiplet to the next-nearest-neighbor chiplet and the nearest-neighbor chiplet.

11. The computing system of claim 9, wherein
the one or more embedded logic bridges includes a first controller and a first physical layer near the next-nearest-neighbor chiplet, the first physical layer being configured to drive signals from the high bandwidth memory stack to the compute chiplet; and
the one or more embedded logic bridges includes a second controller and a second physical layer near the compute chiplet, the second physical layer being configured to drive the signals from the compute chiplet to the next-nearest-neighbor chiplet, the second controller and the second physical layer being a die-to-die controller and a die-to-die physical layer, respectively.

12. The computing system of claim 1, wherein the next-nearest-neighbor chiplet is another compute chiplet or an I/O chiplet, and the I/O chiplet is configured to provide a serializer-deserializer based interface or double data rate based interface.

13. The computing system of claim 12, wherein
the one or more embedded logic bridges includes a first controller and a first physical layer near the next-nearest-neighbor chiplet, the first physical layer being configured to drive signals from the next-nearest-neighbor chiplet to the compute chiplet, the first controller and the first physical layer being a die-to-die controller and a die-to-die physical layer, respectively; and
the one or more embedded logic bridges includes a second controller and a second physical layer near the compute chiplet, the second physical layer being configured to drive the signals from the compute chiplet to the next-nearest-neighbor chiplet, the second controller and the second physical layer being a die-to-die controller and a die-to-die physical layer, respectively.

14. The computing system of claim 1, wherein the active circuitry includes components that extend a signal distance that communication signals can be sent between the compute chiplet and the next-nearest-neighbor chiplet.

15. The computing system of claim 1, wherein:
the next-nearest-neighbor chiplet is spaced from the compute chiplet by at least a characteristic length of the peripheral chiplets; and
the active circuitry extends a range of communications between the compute chiplet and the peripheral chiplets to be at least twice the characteristic length, wherein
the characteristic length of the peripheral chiplets is a width or a length of one of the peripheral chiplets or the characteristic length is 6 mm, 8 mm, or 10 mm.

16. The computing system of claim 1, wherein the active circuitry includes an amplifier that is configured to increase an amplitude of communication signals to compensate for signal attenuation over a distance greater than 8 mm, 10 mm, 12 mm, or 15 mm.

17. The computing system of claim 1, wherein the active circuitry includes a repeater that detects signals and then resends the signals.

18. The computing system of claim 1, wherein:
the peripheral chiplets include an additional chiplet, the nearest-neighbor chiplet and the next-nearest-neighbor chiplet being arranged between the additional chiplet and the compute chiplet; and
the nearest-neighbor chiplet is in a first rank with respect to the compute chiplet, the next-nearest-neighbor chiplet is in a second rank with respect to the compute chiplet, the additional chiplet is in a third rank with respect to the compute chiplet, and the third rank is farther from the compute chiplet than the second rank, and the second rank is farther from the compute chiplet than the first rank.

19. The computing system of claim 1, wherein:
the compute chiplet is configured to perform a memory intensive task, and the peripheral chiplets include more HBMs than can fit along a shoreline of the compute chiplet; and
the memory intensive task is one or more of (i) a high-performance computing task; (ii) a graphics processing task; or (iii) a machine learning task.

20. The computing system of claim 19, wherein the memory intensive task is the machine learning task and the machine learning task includes a calculation selected from the group consisting of a weighted sum calculation; rectified linear unit calculation, a matrix multiplication; an add and normalize calculation; and a multiheaded attention calculation.
